(19) United States
(12) Patent Application Publication
(10) Pub. No.: US 2016/0138564 A1
(43) Pub. Date: May 19, 2016

(54) A FLUID DRIVEN PRIME MOVER SYSTEM

(71) Applicant: Das Ajee KAMATH, Pune (IN)

(72) Inventor: Das Ajee KAMATH, Pimpri Pune (IN)

(21) Appl. No.: 14/900,438

(22) PCT Filed: Jun. 20, 2014
(86) PCT No.: PCT/IN2014/000412

§ 371 Date: Dec. 21, 2015

(30) Foreign Application Priority Data
Jun. 21, 2013 (IN) 2104/MUM/2013

(51) Int. Cl. F03D 3/04

(52) U.S. Cl. CPC F03D 3/0427; F03D 9/028; F03D 11/04

(57) ABSTRACT

A fluid driven prime mover system (20) comprising, a pressure element (30) that combines a first suction element (40) which includes a convergent divergent nozzle system with a convergent divergent nozzle (42), that creates a lower pressure zone (44) which is communicated to a first desired point, with a first head element that includes at least a diffuser nozzle system (32) which converts fluid flow energy into a high pressure head such that said high pressure head is directed towards a second desired point. A first channel element (50) communicates the first desired point to an outlet (62) of a positive displacement fluid motor (60) and a second channel element (52) directs the second desired point to an inlet (64) of the positive displacement fluid motor (60) such that said positive displacement fluid motor (60) is motored by a fluid flow throughput caused by a pressure differential at said inlet (64) and said outlet (62) that results in the positive displacement fluid motor (60) working as a drive unit with power or torque take off.

### TECHNICAL FIELD

The present invention generally relates to machines that extract energy from a fluid flow and converts it into useful work and more specifically to a novel configuration of mechanical devices that manipulate fluid flow parameters cum characteristics, along with devices that are utilised for capture of the energy within the fluid flow to convert into other forms, for utilisation as a Prime Mover drive unit.

### BACKGROUND

Through history, human-kind has utilized the power in fluid streams like wind and rivers by means of machines like wind-mills and water turbines, where energy is tapped and converted for various drive needs like pumping water, grinding etc. Water turbines are used in hydro electric power generation for over a century now. These fluid flow driven motors and machines use centrifugal mechanism/principle and the behavior of fluid flow through these machines is well understood. Another alternative mechanism utilized in fluid motors is Positive displacement mechanism, like in hydraulic motors used in cranes and various rigging equipments.

Both centrifugal mechanism and positive displacement mechanisms have their respective applications and limitations. The former is associated with fluid slippage while imparting velocity to the machine elements, flow rate variation with pressure, comparatively lower viscosity fluids cum higher flow rates, where as the latter is associated with no slippage, comparatively higher pressure cum viscosity, and self priming ability etc.

In the 21^{st} century the environmental concerns like global warming leads to growing demand for green sustainable energy sources and there is new impetus towards fluid flow driven motor technologies in the field of renewable energy sources for electrical power generation and the most prevalently used machines are wind and hydro turbine units, wherein these mechanical devices are placed at suitable locale with availability of wind force or water currents. These machines are essentially rotary centrifugal mechanism based and depend on the fluid flow imparting gain in kinetic energy on the rotor elements like aerofoil profile of blades of turbines and there is large slippage of fluid from between the blade spaces. Furthermore the flow throughput cannot be controlled hence during large flow rate times, like during a storm, the rotating elements can spin beyond their designed RPM's and get damaged, thence requiring Lock down of these turbines. They are usually located at places; far away from city, where there is enough room to install them and no danger to populace. Preferred locations are exposed high areas, hills or small mountains or coastal/Off-shore areas etc. One of the main drawbacks of wind turbines is the location constraint as these systems should be installed away from the cities and areas of electric power demand. The structure of these wind turbines is quite bulky. It is difficult to transport components (like blades) of these wind turbines to the specified wind sites and at times special roads have to be constructed. During the operation, turbine bulk should orient itself along the direction of wind flow, requiring complicated accessory systems resulting in high cost. Yawing, furling and stalling requirements demand special drives and complicated structure, consequently increasing the overall cost of energy. Further these systems, stand still during no flow condition and cannot utilize variation in head generated by fluid level as in case of ocean waves and tides.

These systems lack in terms of low energy capture efficiency, excessive bulk, low Power to weight ratio, low Capacity factor, high transportation, installation, maintenance and operation cost cum time; and hence leads to high cost of power. The high carbon foot print and interference to air and water borne life forms, cum transportation issues is a major drawback. There are no means of fluid mass flow rate control through the devices and hence uncertainty to damage and minimized usage by uncontrolled flow.

It would therefore be advantageous to provide an improved means of energy capture from fluid flow and fluid head, along with means to control and regulate the fluid flow which overcomes the foregoing problems, and/or provides various other benefits and advantages.

### SUMMARY OF THE INVENTION

One embodiment of present invention discloses a fluid driven prime mover system comprising a pressure element that combines a first suction element which includes a convergent divergent nozzle system with at least a convergent divergent nozzle, that creates a lower pressure zone which is communicated to a first desired point, with a first head element that includes at least a diffuser nozzle system which converts fluid flow energy into a high pressure head such that said high pressure head is directed towards a second desired point; and at least a first channel element and at least a second channel element wherein said first channel element communicates the first desired point to an outlet of a positive displacement fluid motor and said second channel element directs the second desired point to an inlet of said positive displacement fluid motor such that said positive displacement fluid motor is motored by a fluid flow throughput caused by a pressure differential at said inlet and said outlet that results in said positive displacement fluid motor working as a drive unit with power or torque take off.

In another embodiment a first self aligning element that allows said convergent divergent nozzle system to align with fluid flow direction, thence improving efficacy of said convergent divergent nozzle system to create optimum lower pressure in varying fluid flow directions.

In another embodiment a second self aligning element that allows said diffuser nozzle system to align with fluid flow direction, thence improving efficacy of said diffuser nozzle system to create optimum high pressure head in varying fluid flow directions.

In another embodiment, a control element system that controls at least any one of said pressure differential, fluid flow throughput and protects said fluid driven prime mover system from damage from at least any one from excessive fluid pressures and excessive fluid flow.

In another embodiment, a second suction element has at least any one of a convergent divergent nozzle system and a first structural element that generates said lower pressure by fluid flow over said first structural element at said first desired point.

In another embodiment, a second head element includes a flow stagnation system that induces fluid flow stagnation at said second desired point with at least one of, a fluid flow direction manipulating fins, a first accumulator to store and direct stagnant fluid, a second accumulator to trap fluid head and a second structural element that compliments said high pressure head in varying fluid flow directions.

In another embodiment, the pressure element has at least any one of said first suction element, said second suction element, said first head element, said second head element, said first channel element, said second channel element, said first self aligning element, said second self aligning element and said control element system is used for creating said differential pressure at said inlet and said outlet, by communicating said first desired point and said second desired point to said input and said output, resulting in said positive displacement fluid motor working as said drive unit.

In another embodiment, a fluid driven prime mover grid system constituting of at least one of said positive displacement fluid motor are driven by plurality of said pressure element, which is used to induce said fluid flow throughput and is controlled by said control elements that controls fluid flow.

In another embodiment, the inlet and said outlet of said positive displacement fluid motor is interchangeable, thereby enabling reversal of direction of torque take off from said positive displacement fluid motor.

In another embodiment, the first channel element and said second channel element is of extendable length, thence capable to capture the optimum fluid flow parameters existing at various levels in the fluid.

In another embodiment, the second accumulator comprises of a fluid head trapping element that allows storing of fluid head at availability for facilitating said throughput when a head differential exists at said input and said output.

In another embodiment, the second accumulator has a buoyant element that keeps said second accumulator afloat when used in fluids such as water, wherein said second accumulator is placed on extendable said second channel element such that said buoyant element lifts and capture fluid head as the fluid level rises and isolate it from surrounding fluid as it falls, thence causing said head differential caused by drop of the surrounding fluid head which is communicated to said outlet and facilitating said throughput.

In another embodiment, a shut off control system constituting of a sealing element and a seal actuator, such that said sealing element isolates a fluid space that lay within said fluid driven prime mover system by means of said seal actuator to isolate said fluid space from spaces outside said fluid driven prime mover system.

In another embodiment, the fluid driven prime mover system is, mounted on a hollow buoyant foundation with a second fluid space and has a buoyancy control system such that said shut off control system isolates said fluid driven prime mover system and said hollow buoyant foundation wherein said buoyancy control system displaces fluid inside said fluid space and said second fluid space, by a lighter fluid to retrieve said fluid driven prime mover system along with said hollow buoyant foundation by floatation.

In another embodiment, by use of said shut off control system and said buoyancy control system, displaces fluid from said fluid spaces by said lighter fluid such that said fluid driven prime mover system is made buoyant and is retrieved to surface by floatation.

In another embodiment, the positive displacement fluid motor is a multiple vane type rotary apparatus.

### BRIEF DESCRIPTION OF DRAWINGS

FIG. 1 illustrates an exemplary embodiment of the present invention depicting an isometric view of the assembly of the embodiments.

FIG. 2 illustrates an exemplary embodiment of the present invention depicting sectional side view of assembly of the embodiments.

FIG. 3 illustrates an exemplary embodiment of the present invention depicting an isometric view of positive displacement fluid motor with its inlet and outlet.

FIG. 4 illustrates an exemplary embodiment of the present invention depicting a sectional view of a combination of pressure element along with suction element.

FIG. 5(a) illustrates an exemplary embodiment of the present invention depicting a top sectional view of positive displacement fluid motor with fluid entering to the input through one direction.

FIG. 5(b) illustrates an exemplary embodiment of the present invention depicting a top sectional view of positive displacement fluid motor with fluid entering to the input through another direction.

FIG. 6 illustrates an exemplary embodiment of the present invention depicting an isometric view of second accumulator.

| Description of Elements | Reference Numeral |
|---|---|
| Fluid Driven Prime mover system | 20 |
| Pressure Element | 30 |
| Diffuser nozzle system | 32 |
| First Self Aligning Element | 34 |
| Second Self Aligning Element | 35 |
| First Accumulator | 36 |
| First Suction Element | 40 |
| Convergent Divergent Nozzle | 42 |
| Lower pressure zone | 44 |
| First Channel Element | 50 |
| Second Channel Element | 52 |
| Fluid Inflow | 54 |
| Fluid outflow | 56 |
| Positive displacement Fluid Motor | 60 |
| Outlet | 62 |
| Inlet | 64 |
| Control Element system | 72 |
| Second structural element | 76 |
| Fluid Flow direction manipulating fins | 78 |
| Generator | 80 |
| Second Accumulator | 90 |
| Fluid Head Trapping element | 92 |
| Buoyant Element | 94 |
| Sealing Element | 102 |
| Seal Actuator | 103 |
| Buoyancy Control System | 104 |
| Buoyant Foundation | 106 |

### DETAILED DESCRIPTION OF INVENTION

The present invention can be fully understood by reading following detail description of some of the embodiments with reference to the accompanying drawings.

In an embodiment of present invention, there is a fluid driven prime mover system (20) which has a positive displacement fluid motor (60) with inlet (64) and outlet (62) for throughput of fluid and during such throughput, energy in fluid is transferred to rotor elements to create torque on a shaft. The throughput is generated by a pressure differential at the outlet (62) and inlet (64) caused by a low pressure due to fluid flow through convergent divergent nozzle (42) that causes lower pressure zone (44) at the throat of the nozzle and a fluid head by a diffuser nozzle system (32) respectively. The fluid driven prime mover system (20) has a pressure element (30) which combines a first suction element (40) including a convergent divergent nozzle system with either a convergent divergent nozzle (42) or a bank of convergent divergent nozzle (42) that creates a lower pressure zone (44) which is communicated to a first desired point.

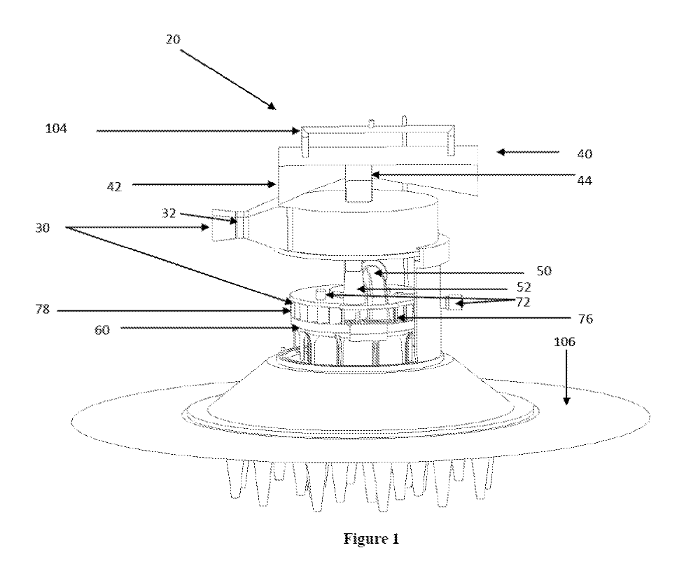

The high pressure or fluid head is created by diffuser nozzle system (32) as shown in FIG. 1 that converts fluid flow energy into a high pressure head. The diffuser nozzle system (32) can be either one diffuser or a bank of diffuser that creates the pressure head at second desired point. A first channel element (50) communicates the first desired point to an outlet (62) and a second channel element (52) communicates the second desired point to an inlet (64) of a positive displacement fluid motor (60).

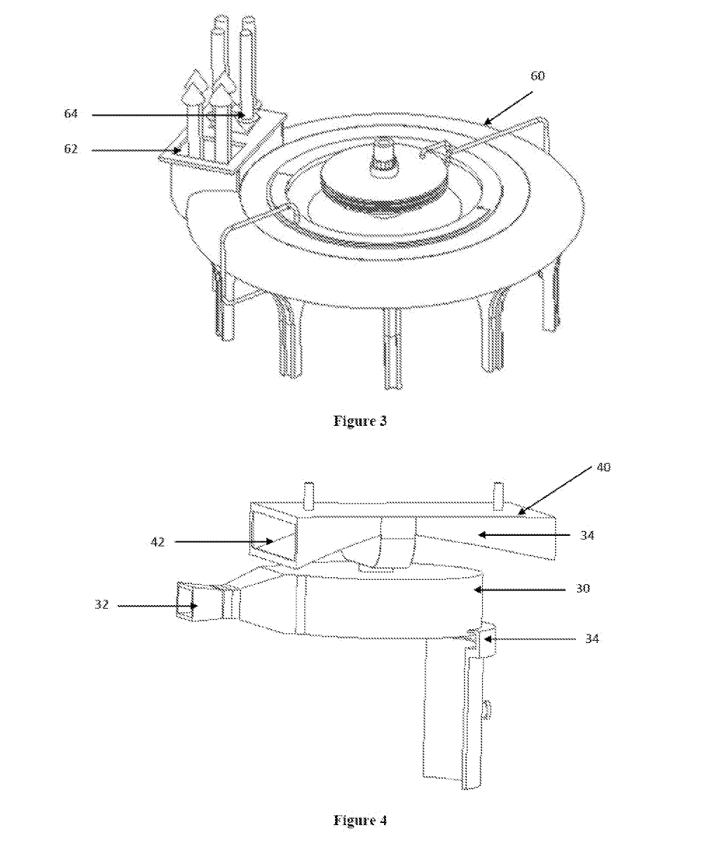

As shown in FIG. 1, the convergent divergent nozzle (42) is connected to first channel element (50), and is free to rotate horizontally and to certain extent vertically and has a surface feature which is the first self aligning element (34) as shown in FIG. 3, that is integrated with the convergent divergent nozzle (42) and would create resistance to flow and correcting moment, unless the convergent divergent nozzle (42) is aligned with the flow thereby resulting in a self aligning characteristic. The convergent divergent nozzle (42) can also have vertical fins on its upper surface for enhancing self aligning feature. The same method is also applicable to the diffuser nozzle system (32) by use of the similar second self aligning element (35). This first channel element (50) allows flow of the fluid from the outlet (62) of the positive displacement fluid motor (60) to the lower pressure zone (44). The diffuser nozzle system (32) of the first head element is connected to second channel element (52) thereby leading to communication of the fluid from the diffuser nozzle system (32) to the inlet (64) of the positive displacement fluid motor (60) through first accumulator (36) where the fluid at higher head accumulates. The diffuser nozzle system (32) can be integrated with convergent divergent nozzle (42) to rotate and align in the direction of fluid flow to create optimum pressure differential as the fluid flow varies in direction.

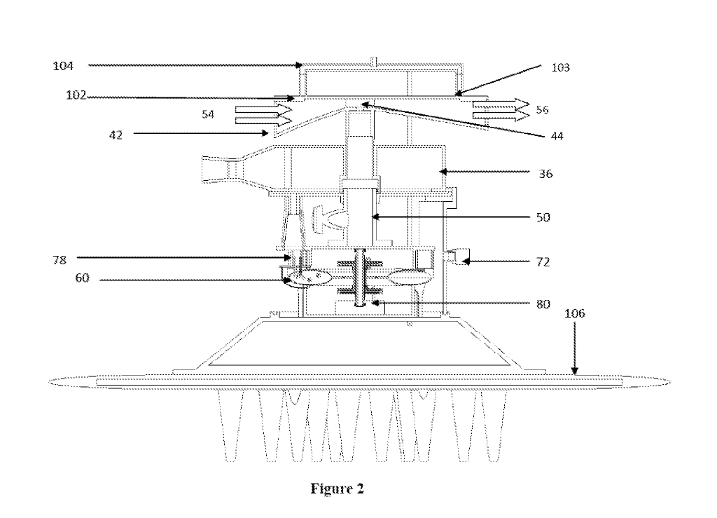

As shown in FIG. 2, the convergent divergent nozzle (42) creates the lower pressure zone (44), due to fluid inflow (54) and fluid outflow (56), the convergent divergent nozzle (42), thereby resulting in suction of fluid from the outlet (62) of the positive displacement fluid motor (60) and flows with the outflow fluid.

As shown in FIG. 3, the positive displacement fluid motor (60) receives fluid into the inlet (64) and converts the pressure differential between the inlet (64) and outlet (62) into an output torque which is transmitted to the generator (80). The fluid from the outlet (62) of the positive displacement fluid motor (60) travels towards the lower pressure zone (44) through first channel element (50).

In another embodiment as in FIG. 4, shows convergent divergent nozzle (42) integrated with diffuser nozzle system (32) and the second structural element (76) for fluid stagnation and their assemblage is allowed to align towards fluid flow direction due to the presence of the first self aligning element (34) of the convergent divergent nozzle (42) and the diffuser nozzle system (32).

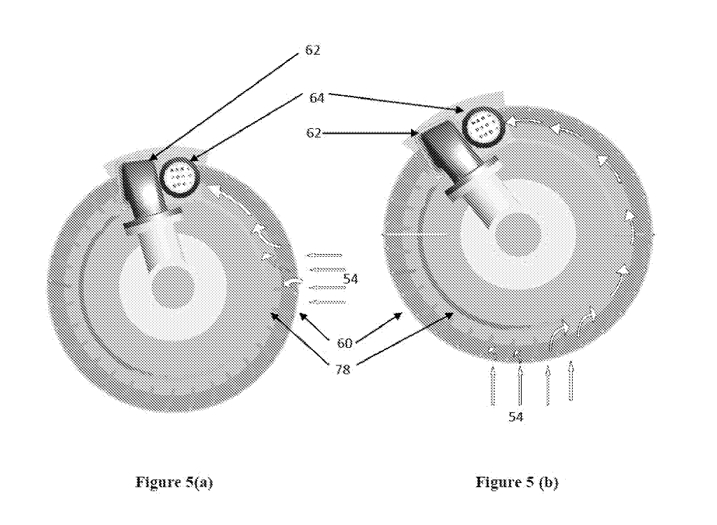

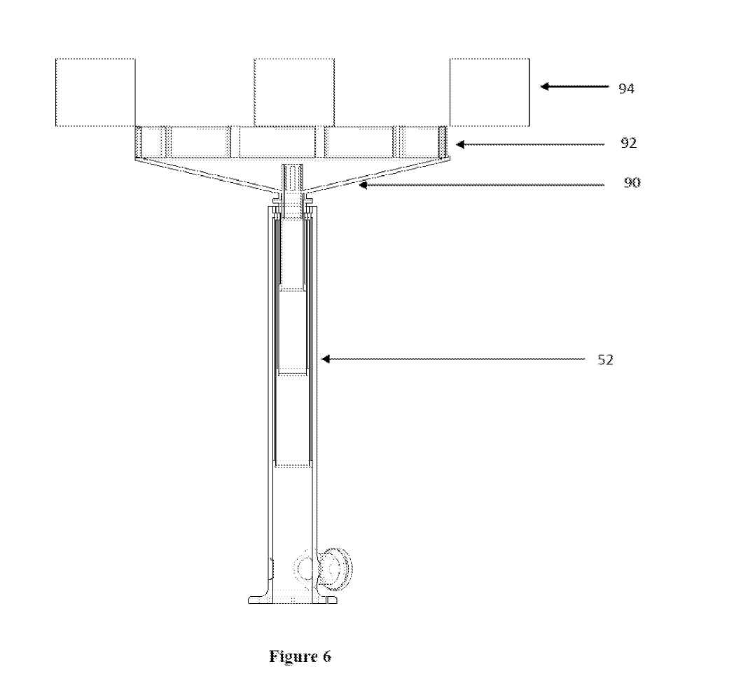

In another embodiment as shown in FIGS. 5(a) and 5(b), a high pressure head induced by fluid flow stagnation at the inlet (64) due to fluid flow direction manipulating fins (78) which manipulates the fluid coming from any possible direction towards the inlet (64), as in case when the fluid flow is at 90° to the radial line from center to inlet (64) as shown in FIG. 5(a) and similarly 200° as shown in FIG. 5(b). This is achieved by fluid flow direction manipulating fins (78) which are restricted to rotate through 90° and only in one direction leading the fluid to the inlet (64). The fins can form a closed channel towards inlet (64). These fins and their functioning forms a part of the fluid stagnation system.

In another embodiment, the first suction element (40) can be either integrated or independent of a second suction element which is a structural part of the fluid driven prime mover system (20). The structural part is so designed that fluid flow over it creates low pressure at a desired point by using Bernoulli's principle and this structure is the first structure element and can be integrated along with the convergent divergent nozzle (42).

In another embodiment, a control element system (72) as shown in FIG. 2, controls the pressure differential, thence controls fluid throughput and protects the components of the fluid driven prime mover system (20) from damage due to excessive fluid pressures and excessive fluid flow which may be caused during very high fluid flow velocities as in case of storms. The control element system (72) on the suction element and first channel element (50) are vacuum breakers or low pressure actuated control valves. Similarly, on the first head element, second head element, second channel element (52) and structural element creating stagnation and high pressure head are fitted with pressure relief valve and safety valve with appropriate settings for protections against over pressure. Such control element system (72) is also fitted on the body of fluid driven prime mover system (20) with appropriate settings for protection against under and over pressure. The pressure elements (30) can be fitted with both vacuum breakers for protection.

In another embodiment, as shown in FIG. 6, a second accumulator (90) that traps fluid head by fluid head trapping element (92) that is communicated to the mouth of the inlet (64). Such a system can be used for trapping fluid when levels are raised at times of high tide or similar situations.

In another embodiment, the second accumulator (90) is fitted with buoyant element (94) that traps fluid head by the fluid head trapping element (92) that is communicated to the mouth of the inlet (64). Such a system can be used for trapping fluid when levels are raised intermittently to varying magnitudes as in case of waves or in similar situations.

In both the above two embodiments where second accumulator (90) is used the low pressure on the outlet (62) is caused by drop of fluid level in the surrounding and the fluid head differential is between the trapped fluid which cannot escape to the surrounding and is contained by the accumulator and the only flow path is through the positive displacement fluid motor (60) to its outlet (62).

In another embodiment, the pressure element (30) can have any one of the first suction element (40), the second suction element, the first head element, the second head element, the first channel element (50), the second channel element (52), the first self aligning element (34), the second self aligning element (35) and the control element system (72) is used for creating the differential pressure at said inlet (64) and said outlet (62), by communicating the first desired point to the inlet (64), the second desired point to the outlet (62), which results in the positive displacement fluid motor (60) working as the drive unit. This can be utilized for a prime mover system during conditions where the pressure element (30) has one or more of its constituents under repair or malfunctioning and the system can be used for power generation and torque take off. In other cases one or more of the element might not be desired.

In another embodiment, there is a fluid driven prime mover grid system which comprises of one or more positive displacement fluid motor (60) which can be driven by more than one pressure element (30) wherein the pressure element (30) have constituent and their arrangement is same as described above.

In another embodiment, the flow throughput is reversed by interchanging the connection of the pressure element (30) to the positive displacement fluid motor (60) inlet (64) and outlet (62) and this interchanging of connections enables reversal of direction of torque take off from said positive displacement fluid motor (60).

In another embodiment, the first channel element (50) and the second channel element (52) is of extendable length, thence capable to capture the optimum fluid flow parameters existing at various levels in the fluid. This extendable feature is a part of second accumulator (90) fitted with buoyant element (94).

In another embodiment, the fluid driven prime mover system (20) is provided with a shut off control system which constitutes of a sealing element (102) and a seal actuator (103) as shown in FIG. 2, which isolates a fluid space that lay within the fluid driven prime mover system (20). The sealing element (102) shown in FIG. 2 are flap type valves and similar shutoff valve are used at all openings where fluid enter and exit. These sealing elements (102) are made fluid tight for appropriate sealing of fluid spaces. The fluid flow direction manipulating fins (78) shown in FIGS. 5(a) and 5(b) also act as sealing element (102) when the flaps are at one extremity of its rotating range where the fins adjust are pressed against hinge element of its adjacent fins or structural element.

In another embodiment, a buoyancy control element is part of the fluid driven prime mover system (20) and is used one after the shut off control system seals and isolates fluid driven prime mover system (20) from outside spaces, displaces the fluids trapped inside the fluid driven prime mover system (20) with lighter fluid like compressed air so that the fluid driven prime mover system (20) becomes buoyant and can be retrieved by floatation. Such a method is useful when said fluid driven prime mover system (20) are used for hydro kinematic power generation. In this system individual constituents of pressure element (30) can be retrieved individually for repair and replacement.

In another embodiment, the fluid driven prime mover system (20) is connected to a hollow buoyant foundation (106) with a second fluid space and has buoyancy control system (104) and shut off control system which isolates fluid driven prime mover system (20) and the hollow buoyant foundation (106) as shown in FIGS. 1 and 2. The buoyancy control system (104) displaces fluid inside the fluid space and the second fluid space, by a lighter fluid to retrieve said fluid driven prime mover system (20) along with the hollow buoyant foundation (106) by floatation. This makes it easy for transportation of the fluid driven prime mover system (20) along with its buoyant foundation (106) in case of off shore hydro kinematic applications where the system can be toed and the use of special purpose vehicle can be avoided. The system can be easily installed after reaching off shore destination and by ballasting the system and submerging it with great degree of control.

In another embodiment the positive displacement fluid motor (60) is a multiple vane type rotary apparatus.

1. A fluid driven prime mover system (20) comprising:
a pressure element (30) that combines a first suction element (40) which includes a convergent divergent nozzle system, with at least a convergent divergent nozzle (42), that creates a lower pressure zone (44) which is communicated to a first desired point, with a first head element that includes at least a diffuser nozzle system (32) which converts fluid flow energy into a high pressure head such that said high pressure head is directed towards a second desired point; and at least a first channel element (50) and at least a second channel element (52) wherein said first channel element (50) communicates the first desired point to an outlet (62) of a positive displacement fluid motor (60) and said second channel element (52) directs the second desired point to an inlet (64) of said positive displacement fluid motor (60) such that said positive displacement fluid motor (60) is motored by a fluid flow throughput caused by a pressure differential at said inlet (64) and said outlet (62) that results in said positive displacement fluid motor (60) working as a drive unit with power or torque take off.

2. The fluid driven prime mover system (20) as claimed in claim 1, wherein a first self aligning element (34) that allows said convergent divergent nozzle (42) system to align with fluid flow direction, thence improving efficacy of said convergent divergent nozzle (42) system to create optimum lower pressure in varying fluid flow direction conditions.

3. The fluid driven prime mover system (20) as claimed in claim 1, wherein a second self aligning element (35) that allows said diffuser nozzle system (32) to align with fluid flow direction, thence improving efficacy of said diffuser nozzle system (32) to create optimum high pressure head in varying fluid flow direction conditions.

4. The fluid driven prime mover system (20) as claimed in claim 1 wherein a control element system (72) that controls at least any one of said pressure differential, fluid flow throughput and protects said fluid driven prime mover system (20) from damage from at least any one from excessive fluid pressures and excessive fluid flow.

5. The fluid driven prime mover system (20) as claimed in claim 1 wherein a second suction element has at least any one of a convergent divergent nozzle system and a first structural element that generates said lower pressure by fluid flow over said first structural element at said first desired point.

6. The fluid driven prime mover system (20) as claimed in claim 1 wherein a second head element includes a flow stagnation system that induces fluid flow stagnation at said second desired point with at least one of, a fluid flow fluid flow direction manipulating fins (78), a first accumulator (36) to store and direct stagnant fluid, a second accumulator (90) to trap fluid head and a second structural element (76) that compliments said high pressure head in varying fluid flow directions.

7. The fluid driven prime mover system (20) as claimed in claim 6, wherein said pressure element (30) has at least any one of said first suction element (40), said second suction element, said first head element, said second head element, said first channel element (50), said second channel element (52), said first self aligning element (34), said second self aligning element (35) and said control element system (72) is used for creating said differential pressure at said inlet (64) and said outlet (62), by communicating said first desired point and said second desired point to said input and said output, resulting in said positive displacement fluid motor (60) working as said drive unit.

8. The fluid driven prime mover system (20) as claimed in claim 7, wherein a fluid driven prime mover grid system constituting of at least one of said positive displacement fluid motor (60) are driven by plurality of said pressure element (30), which is used to induce said fluid flow throughput and is controlled by said control elements that controls fluid flow.

9. The fluid driven prime mover system (20) as claimed in claim 1 wherein said inlet (64) and said outlet (62) of said positive displacement fluid motor (60) is interchangeable, thereby enabling reversal of direction of torque take off from said positive displacement fluid motor (60).

10. The fluid driven prime mover system (20) as claimed in claim 6, wherein said first channel element (50) and said second channel element (52) is of extendable length, thence capable to capture the optimum fluid flow parameters existing at various levels in the fluid.

11. The fluid driven prime mover system (20) as claimed in claims 8, 9 and 10, wherein said second accumulator (90) comprises of a fluid head trapping element (92) that allows storing of fluid head at availability for facilitating said throughput when a head differential exists at said input and said output.

12. The fluid driven prime mover system (20) as claimed in claim 11, wherein said second accumulator (90) has a buoyant element that keeps said second accumulator (90) afloat when used in fluids such as water, wherein said second accumulator (90) is placed on extendable said second channel element (52) such that said buoyant element lifts and capture fluid head as the fluid level rises and isolate it from surrounding fluid as the surrounding fluid level falls, thence causing said head differential caused by drop of the surrounding fluid head which is communicated to said outlet (62) and facilitating said throughput.

13. The fluid driven prime mover system (20) as claimed in claim 8, wherein a shut off control system constituting of a sealing element (102) and a seal actuator (103), such that said sealing element (102) isolates a fluid space that lay within said fluid driven prime mover system (20) by means of said seal actuator (103) to isolate said fluid space from spaces outside said fluid driven prime mover system (20).

14. The fluid driven prime mover system (20) as claimed in claim 13 wherein said fluid driven prime mover system (20) is mounted on a hollow buoyant foundation (106) with a second fluid space and has a buoyancy control system (104) such that said shut off control system isolates said fluid driven prime mover system (20) and said hollow buoyant foundation (106) wherein said buoyancy control system (104) displaces fluid inside said fluid space and said second fluid space, by a lighter fluid to retrieve said fluid driven prime mover system (20) along with said hollow buoyant foundation (106) by floatation.

15. The fluid driven prime mover system (20) as claimed in claim 14, wherein by use of said shut off control system and said buoyancy control system (104), displaces fluid from said fluid spaces by said lighter fluid such that any one of said pressure element (30) and said fluid driven prime mover system (20) is made buoyant and is retrieved to surface by floatation.

16. The fluid driven prime mover system (20) as claimed in claim 8, wherein said positive displacement fluid motor (60) is a multiple vane type rotary apparatus.
